(19) United States
(12) Patent Application Publication
(10) Pub. No.: US 2004/0095547 A1
(43) Pub. Date: May 20, 2004

(54) Substrate bonding apparatus for liquid crystal display device

(76) Inventors: Sang Seok Lee, Taegu-kwangyokshi (KR); Soo Min Kwak, Chilgok-gun (KR); Jong Han Kim, Taegu-kwangyokshi (KR)

Correspondence Address: MCKENNA LONG & ALDRIDGE LLP, 1900 K STREET, NW, WASHINGTON, DC, 20006, US

(21) Appl. No.: 10/661,473

(22) Filed: Sep. 15, 2003

(30) Foreign Application Priority Data
Nov. 18, 2002 (KR) P2002-0071711

(51) Int. Cl. G02F 1/1333

(52) U.S. Cl. 349/187

(57) ABSTRACT

An apparatus for manufacturing an LCD device having an improved substrate bonding apparatus, in which substrate loading and unloading processes are performed at the same time, thereby decreasing manufacturing time.

This application claims the benefit of the Korean Application No. P2002-71711 filed on Nov. 18, 2002, which is hereby incorporated by reference for all purposes as if fully set forth herein. This application incorporates by reference two co-pending application Ser. No. 10/184,096, filed on Jun. 28, 2002, entitled “SYSTEM AND METHOD FOR MANUFACTURING LIQUID CRYSTAL DISPLAY DEVICES”, (Attorney Docket Number 8733.666.00) and Ser. No. 10/184,088, filed on Jun. 28, 2002, entitled “SYSTEM FOR FABRICATING LIQUID CRYSTAL DISPLAY AND METHOD OF FABRICATING LIQUID CRYSTAL DISPLAY USING THE SAME” (Attorney Docket Number 8733.684.00), as if fully set forth herein.

### BACKGROUND OF THE INVENTION

1. Field of the Invention

The present invention relates to an apparatus, and more particularly, to an apparatus for manufacturing liquid crystal display (LCD) devices.

2. Discussion of the Related Art

With the expansion of the information society, a need has arisen for displays capable of producing high quality images in thin, lightweight packages and that consume little power. To meet such needs, research has produced a variety of flat panel display devices, including liquid crystal displays (LCD), plasma displays (PDP), electro luminescent displays (ELD), and vacuum fluorescent displays (VFD). Some of these display technologies have already been applied in information displays.

Of the various types of flat panel display devices, LCD devices, having excellent display quality, light weight, thin dimensions, and consuming low amounts of power, have been very widely used. In fact, in portable devices, such as notebook PC computers, LCD technology has already replaced cathode ray tubes (CRT) as the display of choice. Moreover, even in desktop PCs and in TV monitors, LCDs devices are becoming more common.

Despite various technical developments in LCD technology, however, research in enhancing the picture quality of LCD devices has been lacking compared to research in other features and advantages of LCD devices (e.g., light weight, thin profile, low power consumption, etc.). Therefore, to increase the use of LCD devices as displays in various fields of application, LCD devices capable of expressing high quality images (e.g., images having a high resolution and a high luminance) with large-sized screens, while still maintaining a light weight, minimal dimensions, and low power consumption must be developed.

LCDs generally include an LCD panel for displaying pictures and a driving part for providing driving signals to the LCD panel. Typically, LCD panels include first and second glass substrates bonded to each by a sealant material other while being spaced apart by a cell gap, the uniformity of which is maintained by spacers. Subsequently, a layer of liquid crystal material is injected into the cell gap.

The first glass substrate (i.e., thin film transistor (TFT) array substrate), supports a plurality of gate lines spaced apart from each other at a fixed interval and extending along a first direction; a plurality of data lines spaced apart from each other at a fixed interval and extending along a second direction, substantially perpendicular to the first direction, wherein pixel regions are defined by crossings of the gate and data lines; a plurality of pixel electrodes arranged in a matrix pattern within respective ones of the pixel regions; and a plurality of thin film transistors (TFTs) capable of transmitting signals from the data lines to corresponding ones of the pixel electrodes in response to signals applied to respective ones of the gate lines.

The second glass substrate (i.e., color filter substrate) supports a black matrix layer for preventing light leakage in areas outside the pixel regions; a color filter layer (R,G,B) for selectively transmitting light having predetermined wavelengths; and a common electrode for displaying pictures.

FIG. 1 illustrates a method by which the related art LCD device is fabricated.

Referring to FIG. 1, the first glass substrate 51 is transported to a sealant deposition station 11 (where the sealant material is deposited on the first glass substrate 51) and then to a sealant drying station 12 (where the deposited sealant material is dried). The second glass substrate 52 is carried to a silver (Ag) deposition station 13 (where Ag is deposited on the second glass substrate 52) and a spacer dispersion station 12 (where the spacers are dispersed onto the second glass substrate 52). Next, the first and second glass substrates 51 and 52 are loaded into a bonding station 15 (where the first and second glass substrates 51 and 52 are bonded to each other via the sealant material) by loaders. Subsequently, the loaders unload the bonded first and second glass substrates 51 and 52 from the bonding station 15 load the bonded first and second glass substrates 51 and 52 into a hardening station 16 (where the sealant material is hardened and patterned to form a liquid crystal injection inlet). Next, liquid crystal material is injected through the liquid crystal injection inlet and into the cell gap between the bonded first and second glass substrates 51 and 52 at the liquid crystal injection station 17. After injecting the liquid crystal material, the liquid crystal injection inlet is sealed at a sealing station 18 to form an LCD panel. Finally, the LCD panel is cleaned at the panel cleaning station 19 and the process of manufacturing the LCD panel is completed.

Fabricating LCD panels using the aforementioned related art liquid crystal injection method, however, is disadvantageous because the productivity of such liquid crystal injection methods is poor. More specifically, within the aforementioned related art manufacturing process, the first and second glass substrates must be loaded into and out from the bonding station 15 by the same loader. Accordingly, substrates cannot be loaded into the bonding station by the loader until the loader unloads previously bonded substrates and transports them to the next processing station. As a result, the time required to manufacture LCD devices may become excessive.

### SUMMARY OF THE INVENTION

Accordingly, the present invention is directed to a substrate bonding apparatus for manufacturing LCD devices that substantially obviates one or more problems due to limitations and disadvantages of the related art.

An advantage of the present invention provides an improved apparatus for manufacturing LCD panels wherein substrates may be loaded and unloaded substantially simultaneously, thereby decreasing the amount of time required to manufacture LCD devices.

Additional features and advantages of the invention will be set forth in the description which follows, and in part will be apparent from the description, or may be learned by practice of the invention. These and other advantages of the invention will be realized and attained by the structure particularly pointed out in the written description and claims hereof as well as the appended drawings.

To achieve these and other advantages and in accordance with the purpose of the present invention, as embodied and broadly described, an apparatus for manufacturing liquid crystal display (LCD) devices may, for example, include substrate bonding stations arranged in parallel with one another, wherein each of the substrate bonding stations may bond first glass substrates to second glass substrates; loaders for loading the first and second glass substrates into corresponding ones of the substrate bonding stations, wherein the loaders are provided at front portions of corresponding ones of the substrate bonding stations; unloaders for unloading the bonded substrates from corresponding ones of the substrate bonding stations; and a plurality of hardening stations arranged at rear portions of corresponding ones of the unloaders for hardening a sealant material deposited onto one of the first and second glass substrates and arranged between the bonded first and second glass substrates.

In one aspect of the present invention, a number of loaders and unloaders may correspond with a number of the substrate bonding stations used within the apparatus of the present invention.

In another aspect of the present invention, one loader may be provided for at least two substrate bonding stations, wherein the at least two substrate bonding stations are arranged in parallel with one another.

In still another aspect of the present invention, the hardening stations may be arranged in series with corresponding ones of the loaders.

In yet another aspect of the present invention, the hardening stations may be arranged in parallel with each other and in correspondence with respective ones of the loaders.

In yet a further aspect of the present invention, the substrate bonding apparatus of the present invention may, for example, include a lower chamber unit, wherein the lower chamber unit includes open front and rear portions; an upper chamber unit, selectively joinable to the lower chamber unit and capable of being raised and lowered, wherein the upper chamber unit includes open front and rear portions; an upper stage provided within the upper chamber unit for securing a first substrate; a lower stage provided within the lower chamber unit for securing a second substrate; and a sealing member provided on a surface of at least one of the upper and lower chamber units, wherein the sealing member seals an interior space definable by the upper and lower chamber units coupled together.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a schematic layout of a related art apparatus for manufacturing LCD devices;

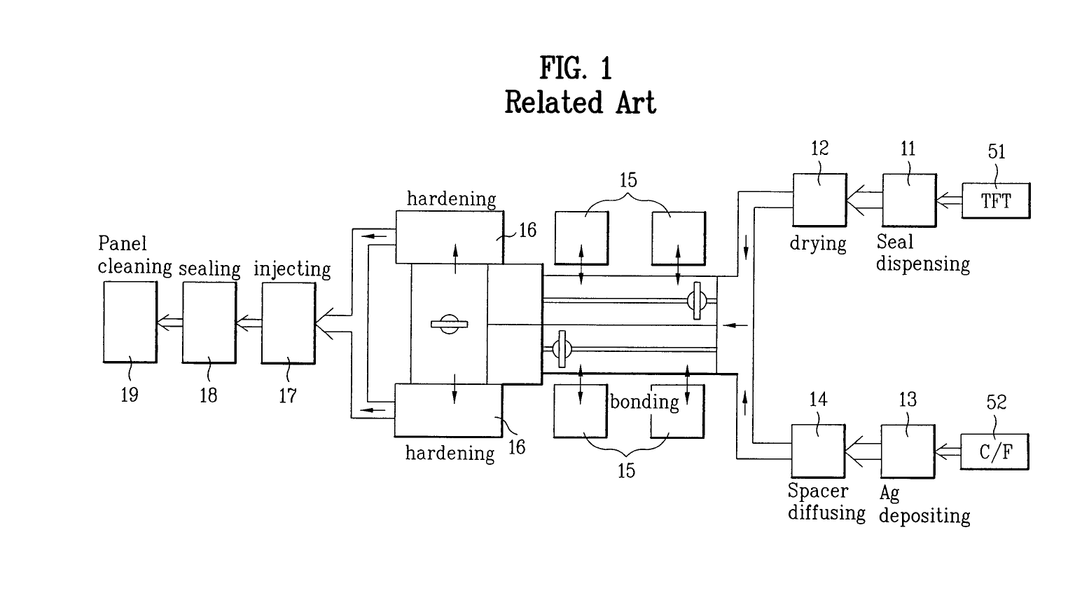

FIG. 2 illustrates a schematic layout of an apparatus for manufacturing LCD devices in accordance with the principles of the present invention; and

FIG. 3 illustrates a cross-sectional view of a substrate bonding station in the apparatus for manufacturing LCD devices according to the principles of the present invention.

### DETAILED DESCRIPTION OF THE ILLUSTRATED EMBODIMENTS

Reference will now be made in detail to embodiments of the present invention, examples of which are illustrated in the accompanying drawings. Wherever possible, the same reference numbers will be used throughout the drawings to refer to the same or like parts.

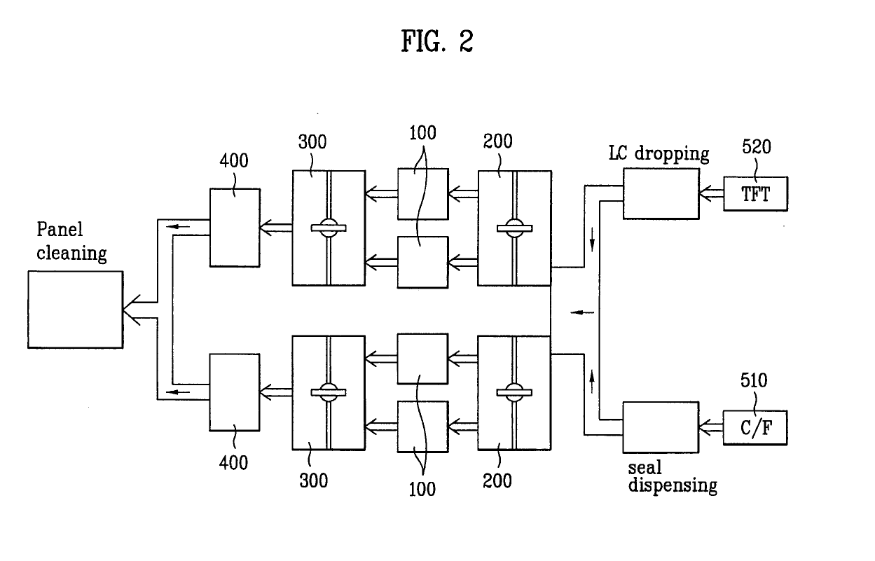

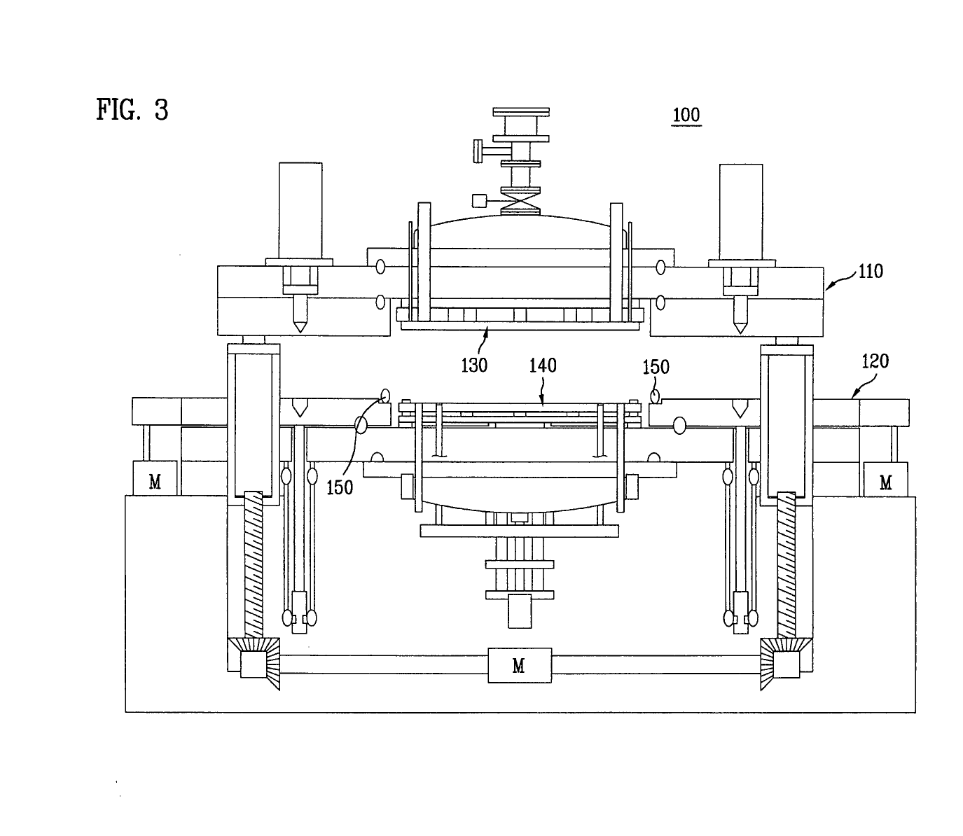

FIG. 2 illustrates a schematic layout of an apparatus for manufacturing LCD devices in accordance with the principles of the present invention. FIG. 3 illustrates a cross-sectional view of a substrate bonding station in the apparatus for manufacturing LCD devices according to the principles of the present invention.

Referring to FIG. 2, an apparatus for manufacturing liquid crystal display (LCD) devices in accordance with the principles of the present invention may, for example, be provided with at least one substrate bonding station 100, at least one loader 200, and at least one unloader 300. In one aspect of the present invention, the apparatus for manufacturing LCD devices may further include at least one hardening station 400.

Referring to FIG. 3, each substrate bonding station 100 may, for example, include an upper chamber unit 110, a lower chamber unit 120, an upper stage 130, a lower stage 140, and a sealing member 150.

In one aspect of the present invention, upper and lower stages 130 and 140 may be fixed within the upper chamber unit 110 and the lower chamber unit 120, respectively. In another aspect of the present invention, first and second substrates 510 and 520, respectively, may be secured to corresponding ones of the upper and lower stages 130 and 140, respectively. As will be described in greater detail below, the upper and lower chamber units 110 and 120 may be selectively joined to each other to define an interior space.

According to the principles of the present invention, the upper chamber unit 110 may be selectively raised and lowered to be selectively joined to the lower chamber unit 120. When the upper chamber unit 110 is raised, front and rear regions of both the upper chamber unit 110 and the lower chamber unit 120 may be completely open to the external environment such that bonded or unbonded substrates may be loaded and unloaded from the substrate bonding station 100. The sealing member 150 may be provided on the surface of at least of the upper and lower chamber units 110 and 120. When the upper and lower chamber units 110 and 120 are joined each other, an interior space between the upper and lower stages 130 and 140 may be substantially sealed from the external environment. Accordingly, the sealing member 150 may substantially prevent the stages 130 and 140, to which the first and second glass substrates 510 and 520, respectively, are secured and enclosed within the interior space, from being exposed to the exterior environment. Once loaded into the substrate bonding station 100, the upper chamber unit 110 may be lowered such that the first glass substrate 510 may be partially pressed to the second glass substrate 520 due to the weight of the upper chamber unit 110. Moreover, the thickness of the sealing member 150 may be sufficient to permit the substrates to contact each other when compressed by the weight of the upper chamber unit 110.

Next, the interior space may be substantially evacuated to create a vacuum. In one aspect of the present invention, the volume of the interior space may be minimized such that a time required to evacuate the interior space may be minimized during bonding of the first and second substrates 510 and 520.

Next, the first and second glass substrates 510 and 520 may be completely bonded to each other in a venting process wherein a gas such as nitrogen may be injected into the interior space. According to the principles of the present invention, the first and second substrates 510 and 520 may be completely bonded to each other, for example, due to a difference in pressure between a cell gap between the first and second substrates and the vented interior space between the chamber units 110 and 120.

According to the principles of the present invention, all sides of the substrate bonding station 100 may be open to the external environment and may include a substrate loading site and a substrate unloading site. In one aspect of the present invention, the substrate loading site may be provided at a different side than the substrate unloading side. Accordingly, within the apparatus for manufacturing LCD devices of the present invention, the loader 200, the substrate bonding station 100, and the unloader 300 may be arranged in series with each respect to each other. In one aspect of the present invention, a plurality of substrate bonding stations 100 may be provided within the apparatus for manufacturing LCD devices in accordance with the principles of the present invention. In another aspect of the present invention, the plurality of substrate bonding stations 100 may be arranged in parallel with respect to each other.

Referring to FIG. 2, sealant material may be deposited onto the first glass substrate 510 and liquid crystal material may be dispensed onto the second glass substrate 520. In another aspect of the present invention, however, both the sealant material may be deposited and the liquid crystal material may be dispensed on any one of the first and second glass substrates 510 and 520. In one aspect of the present invention, the first glass substrate 510 may be provided as a color filter (C/F) substrate and the second glass substrate 520 may be provided as a thin film transistor (TFT) substrate. Alternatively, the first glass substrate 510 may be provided as the TFT substrate while the second glass substrate 520 may be provided as the C/F substrate.

According to the principles of the present invention, the loaders 200 may be provided at first sides (e.g., front regions) of corresponding ones of the substrate bonding stations 100. After being provided with the sealant and liquid crystal materials, each loader 200 may load the first and second glass substrates 510 and 520 into a corresponding one of the substrate bonding stations 100. In one aspect of the present invention, one loader 200 may, for example, be provided for every two substrate bonding stations 100. In another aspect of the present invention, a loader 200 may be provided for each substrate bonding station 100 such that the number of loaders 200 equals the number of substrate bonding stations 100 used within the apparatus of the present invention. In yet another aspect of the present invention, only one loader 200 may be provided for all of the substrate bonding stations 100 within the apparatus of the present invention.

According to the principles of the present invention, the unloaders 300 may be provided at second sides (e.g., rear regions) of corresponding ones of the substrate bonding stations 100, opposite the front portions where the loaders 200 are arranged. After being bonded together within the substrate bonding stations 100, each unloader 300 may unload the bonded first and second substrates 510 and 520. In one aspect of the present invention, one unloader 300 may, for example, be provided for every two substrate bonding stations 100. In another aspect of the present invention, an unloader 300 may be provided for each substrate bonding station 100 such that the number of unloaders 300 equals the number of substrate bonding stations 100 used within the apparatus of the present invention. In yet another aspect of the present invention, only one unloader 300 may be provided for all of the substrate bonding stations 100 within the apparatus of the present invention.

According to the principles of the present invention, the plurality of hardening stations 400 may be provided at rear regions of corresponding ones of the unloaders 300 and may harden the sealant material arranged between the bonded first and second glass substrates 510 and 520. In one aspect of the present invention, the hardening stations 400 may be arranged in series with respect to corresponding ones of the unloaders 300 and the substrate bonding stations 100. In another aspect of the present invention, the hardening stations 400 may be arranged in parallel with each other. In still another aspect of the present invention, the hardening station 400 may direct at least one of UV light and/or heat to the sealant material between the bonded first and second glass substrates 510 and 520 to harden the sealant material.

A method by which LCD devices may be fabricated in accordance with the principles of the present invention will now be described in greater detail below.

In one aspect of the present invention, loaders 200 may receive an unbonded first glass substrate 510, on which the sealant may be deposited, and an unbonded second glass substrate 520, on which the liquid crystal may be dispensed. Next, the unbonded first and second glass substrates 510 and 520 may be loaded into a corresponding one of the substrate bonding stations 100 via substrate loading sites, arranged in front sides of the substrate bonding stations 100. Subsequently, the upper chamber unit 110 of the substrate bonding station 100 may be lowered such that the first glass substrate 510 may be pressed to the second glass substrate 520, due to the weight of the upper chamber unit 110 and due the pressure difference present during the aforementioned venting process. Accordingly, the thickness of the sealing member 150 may be set in accordance with the magnitude of pressure applied to the first and second glass substrates 510 and 520.

In one aspect of the present invention, the sealing member 150 may be set to have a relatively small thickness if it is required to press the first and second glass substrates 510 and 520 with a relatively low pressure. However, the sealing member 150 may be set to have a relatively large thickness if it is required to press the first and second glass substrates 510 and 520 with a relatively high pressure.

After the first and second glass substrates 510 and 520 have been bonded to each other, the unloader 300 may be arranged proximate unloading sites, arranged in rear sides of the substrate bonding stations 100, to unload the bonded first and second glass substrates 510 and 520.

According to the principles of the present invention, the loaders 200 may load pairs of unbonded first and second glass substrates 510 and 520 into corresponding ones of substrate bonding stations 100 via the loading sites substantially simultaneously while the unloaders 300 unloading bonded pairs of the first and second glass substrates 510 and 520 from the corresponding ones of the substrate bonding stations 100. Accordingly, the substrate bonding process of the present invention may be performed as a substantially continuous, linear operation such that unbonded pairs of substrates may be consecutively bonded without substantial delay.

After the bonded first and second glass substrates 510 and 520 have been unloaded by the unloaders 300, they may be transported to corresponding ones of the hardening stations 400, thereby completing the fabrication of the LCD device.

As mentioned above, the substrate bonding apparatus for manufacturing LCD devices in accordance with the principles of the present invention is advantageous because LCDs may be fabricated by dispensing liquid crystal material onto the substrate. Accordingly, the amount of time required to fabricate LCDs may be reduced compared to the amount of time required to fabricate LCDs via the related art liquid crystal injection method. For example, one substrate, on which the liquid crystal is dispensed, may be bonded to another substrate on which sealant material is deposited. The bonded substrates may then be hardened. Accordingly, the related art liquid crystal injection process may be omitted.

Further, a process for manufacturing LCD devices may be performed substantially linearly, thereby decreasing the amount of time required for manufacturing a LCD device. Accordingly, a process of unloading bonded substrates may be performed substantially simultaneously with the process of loading unloaded substrates, thereby minimizing a delay in the fabrication of the LCD generateable during loading and unloading of the substrates.

According to the principles of the present invention, the apparatus for manufacturing LCD devices may be optimally arranged such that a process of manufacturing LCD devices may be efficiently performed while minimizing the amount of time required to manufacture the LCD devices. Accordingly, LCD devices may be mass produced using the apparatus for manufacturing LCD devices according to the principles of the present invention.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An apparatus for manufacturing liquid crystal display (LCD) devices, comprising:
at least one substrate bonding station for bonding unbonded first and second substrates, wherein the substrate bonding station includes first and second sides;
at least one loader arranged at the first side of the substrate bonding station for loading the unbonded first and second substrates into the substrate bonding station; and
at least one unloader arranged at the second side for unloading bonded ones of the first and second substrates, wherein the substrate bonding station includes third and fourth sides, wherein third side is proximate the fourth side.

2. The apparatus according to claim 1, wherein the at least one substrate bonding station includes a plurality of substrate bonding stations.

3. The apparatus according to claim 2, wherein the plurality of substrate bonding stations are arranged parallel to each other.

4. The apparatus according to claim 2, wherein the at least one loader includes a plurality of loaders.

5. The apparatus according to claim 4, wherein the plurality of loaders are arranged parallel to each other.

6. The apparatus according to claim 4, wherein each loader loads the unbonded substrates into a single substrate bonding station.

7. The apparatus according to claim 6, wherein each loader loads the unbonded substrates into a plurality of substrate bonding stations.

8. The apparatus according to claim 2, wherein the at least one unloader includes a plurality of unloaders.

9. The apparatus according to claim 8, wherein the plurality of unloaders are arranged parallel to each other.

10. The apparatus according to claim 8, wherein each unloader unloads the bonded substrates from a single substrate bonding station.

11. The apparatus according to claim 10, wherein each unloader unloads the bonded substrates from a plurality of substrate bonding stations.

12. The apparatus according to claim 1, further comprising at least one hardening station for hardening a sealant material arranged between the bonded ones of the first and second substrates, wherein the at least one hardening station is arranged proximate the fourth side of the at least one unloader and wherein the at least one unloader loads the bonded ones of the first and second substrates into the at least one hardening station.

13. The apparatus according to claim 12, wherein the at least one hardening station includes a plurality of hardening stations.

14. The apparatus according to claim 13, wherein the at plurality of hardening stations are arranged parallel to each other.

15. The apparatus according to claim 13, wherein each unloader loads the bonded substrates into a single hardening station.

16. The apparatus according to claim 12, wherein a one-to-one correspondence exists between the at least one hardening station and the at least one loader.

17. The apparatus according to claim 12, wherein the at least one hardening station directs UV light to the sealant material.

18. The apparatus according to claim 12, wherein the at least one hardening station directs heat to the sealant material.

19. The apparatus according to claim 1, wherein the at least one substrate bonding station includes:
a lower chamber unit openings in the first and second sides;
an upper chamber unit including openings in the first and second sides, the upper chamber unit being raiseable and lowerable with respect to the lower chamber unit being and joinable to the lower chamber unit;
an upper stage fixed to the upper chamber unit for securing the unbonded first substrate;
a lower stage fixed to the lower chamber unit for securing the unbonded second glass substrate; and
a sealing member provided on a surface of at least one of the upper and lower chamber units for sealing an interior space surrounding the first and second substrates, wherein the sealed interior space is definable by joined ones of the upper and lower chamber units.

20. A method of display device, comprising:
providing unbonded first and second substrates;
loading the unbonded first and second substrates through a first side of a bonding station;
bonding the loaded first and second substrates within the bonding station; and
unloading the bonded first and second substrates from the bonding station through a second side, different from the first side.
